(19) United States
(12) Patent Application Publication
(10) Pub. No.: US 2003/0148166 A1
(43) Pub. Date: Aug. 7, 2003

(54) Fuel and wastewater storage device and method for a fuel cell

(76) Inventors: Charles R. DeJohn, Rochester, NY (US); Arthur R. Williams, Spencerport, NY (US)

Correspondence Address: VINCENT A. CICHOSZ, DELPHI TECHNOLOGIES, INC., Legal Staff, Mail Code: 480-414-420, P.O. Box 5052, Troy, MI, 48007-5052, US

(21) Appl. No.: 10/068,704

(22) Filed: Feb. 5, 2002

(51) Int. Cl. H01M 8/04; B65D 6/00

(52) U.S. Cl. 429/34; 429/13; 220/4.12

(57) ABSTRACT

A fuel and wastewater storage device for a fuel cell includes: a housing having an interior; a movable barrier dividing the interior into a first cavity and a second cavity; a fuel port located at the first cavity; and a wastewater port located at the second cavity, wherein the storage device is sized to be contained within a portable electric device. A fuel cell system includes: a fuel cell; a fuel and wastewater storage device in fluid communication with the fuel cell, the storage device includes: a housing having an interior; and a movable barrier dividing the interior into a first cavity and a second cavity. A method of storing a fuel and a wastewater at a storage device for a fuel cell system, the method includes: holding the fuel at a first cavity of the storage device; moving the fuel from the first cavity to a fuel cell; consuming the fuel at the fuel cell; producing the wastewater at the fuel cell; moving the wastewater from the fuel cell to a second cavity at the storage device; and holding the wastewater at the second cavity.

### BACKGROUND

A number of fuel cells suitable for use with portable electronic devices are becoming available today. Such fuel cells are commonly called micro or miniature fuel cells because the fuel cell is small and can fit within the portable electronic device. The present disclosure generally relates to a fuel and wastewater storage device for a fuel cell utilized with a portable electronic device.

Miniature fuel cells have been developed to run electronic applications. Such miniature fuel cells run on methanol and/or ethanol mixed with water. While such miniature fuel cell technology exists, the prior art does not describe how to handle the wastewater that is expelled from the fuel cell after the fuel cell has consumed the fuel product. Moreover, handling the wastewater from one of these micro-fuel cells is an important problem because of the limited space associated with the portable electronic device.

### SUMMARY

A fuel and wastewater storage device for a fuel cell includes: a housing having an interior; a movable barrier that divides the interior into a first cavity and a second cavity; a fuel port located at the first cavity; and a wastewater port located at the second cavity, wherein the storage device is sized to be contained within a portable electrical device. A fuel cell system includes: a fuel cell; a fuel and wastewater storage device in fluid communication with the fuel cell, the storage device includes: a housing having an interior; and a movable barrier that divides the interior into a first cavity and a second cavity. A method of storing a fuel and a wastewater at a storage device for a fuel cell system, the method includes: holding the fuel at a first cavity of the storage device; moving the fuel from the first cavity to a fuel cell; consuming the fuel at the fuel cell; producing the wastewater at the fuel cell; moving the wastewater from the fuel cell to a second cavity at the storage device; and holding the wastewater at the second cavity.

### BRIEF DESCRIPTION OF THE DRAWINGS

Referring to the exemplary drawings wherein like elements are numbered alike in the several Figures:

FIG. 1 is a schematic of a fuel cell with a fuel and wastewater storage device (“storage device”) with the storage device containing mostly fuel;

FIG. 2 is a schematic of the fuel cell of FIG. 1 with the storage device containing mostly wastewater; and

FIG. 3 is a schematic of the fuel cell of FIG. 1 with a plurality of storage devices;

FIG. 4 is a schematic of an alternative embodiment of a fuel cell with a storage device; and

FIG. 5 is a schematic of a fuel cell system located in a portable electronic device.

### DETAILED DESCRIPTION

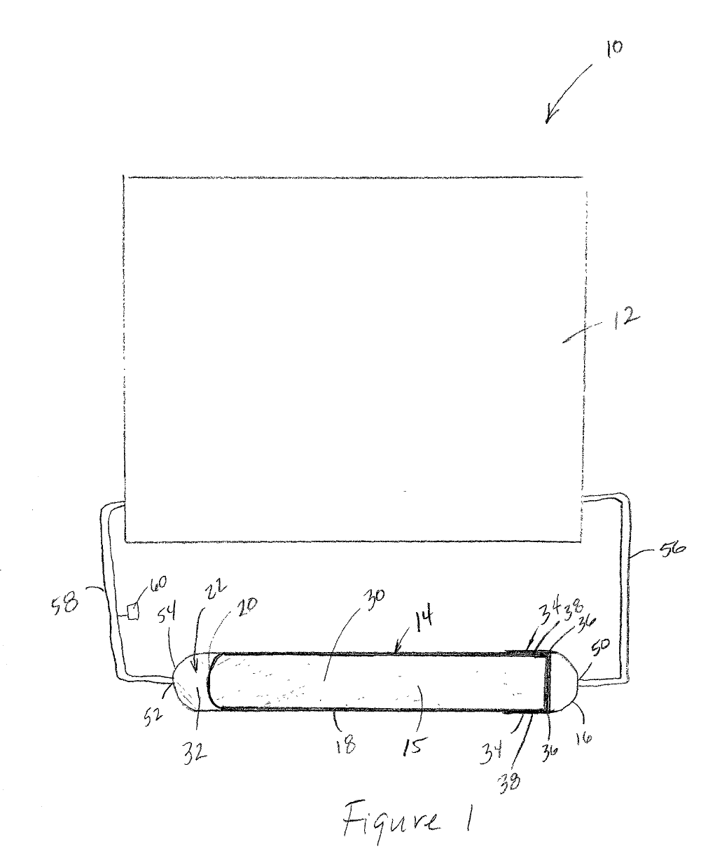

Referring to FIG. 1, an exemplary embodiment of a fuel cell system 10 is illustrated. Fuel cell system 10 includes a fuel cell 12 and a combined fuel and wastewater storage device (“storage device”) 14. Storage device 14 holds and stores a fuel 15 for fuel cell 12. Fuel cell 12 consumes fuel 15 and generates electricity to operate a portable electric device. Fuel 15 includes a methanol fuel mixed with water, an ethanol fuel mixed with water, or a combined methanol/ethanol fuel mixed with water.

Storage device 14 includes a cap 16, a main body 18, and a bladder 20. Cap 16 and main body 18 are made of materials, such as plastic or metal. Cap 16 and main body 18 may be any shape, but in the exemplary embodiment form a cylindrical shape. Bladder 20 is made of a flexible material, such as an elastic or rubberized material. Bladder 20 expands when filled and retracts when emptied.

Bladder 20 is located within an interior 22 of main body 18, thereby creating a first cavity 30, which is located inside bladder 20, and a second cavity 32, which is located outside bladder 20. An end portion 34 of bladder 20 extends around a first end 36 of main body 18 and is located along an outside wall 38 of main body 18. An adhesive may be used to secure end portion 34 to outside wall 38. Cap 16 fits over end portion 34 further securing end portion 34 to outside wall 38. Cap 16 may be screwed or snapped onto end portion 34.

First cavity 30 is filled with fuel 15, which includes the methanol and/or ethanol mixed with water. As fuel 15 is added to first cavity 30, bladder 20 expands to fill interior 22. The expansion of bladder 20 causes first cavity 30 to occupy at least 99% and preferably all of interior 22, which causes second cavity 32 to be nonexistent. Because second cavity 32 occupies less than 1% of interior 22, there are only trace amounts of air in second cavity 32. The expansion of bladder 20 causes first cavity 30 to be under pressure. Cap 16 is then secured over first end 36 and end portion 34. Once fuel 15 is located within first cavity 30, storage device 14 is complete and can be installed in fuel cell system 10.

Storage device 14 connects to fuel cell 12 at two locations, a fuel port 50 and a wastewater port 52. Fuel port 50 is located at cap 16 and wastewater port 52 is located at an end section 54 of main body 18. Fuel port 50 connects to a fuel connection device 56 and wastewater port 52 connects to a wastewater connection device 58. Both fuel and wastewater connection devices 56 and 58 may be a tube, a pipe, or other similar device to transport fluid. Both fuel and wastewater connection devices 56 and 58 connect to fuel cell 12. Fuel connection device 56 transports fuel 15 from first cavity 30 to fuel cell 12. Wastewater connection device 58 transports wastewater from fuel cell 12 to second cavity 32.

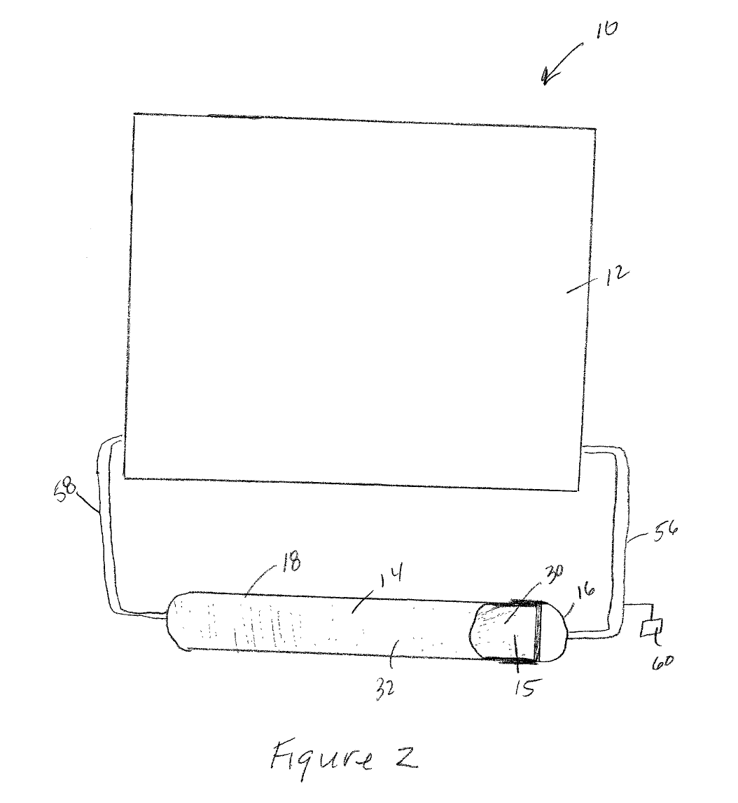

FIG. 2 is similar to FIG. 1, except that FIG. 2 illustrates first cavity 30 as being almost empty of fuel 15. As fuel 15 leaves first cavity 30 and enters fuel cell 12, bladder 20 retracts, which allows wastewater to enter and fill second cavity 32. Eventually, fuel 15 is emptied from first cavity 30 and wastewater fills second cavity 32.

Fuel cell system 10 operates as follows. Storage device 14, which has first cavity 30 filled with fuel 15, is connected to fuel cell system 10. Because bladder 20 is expanded and filled with fuel 15, bladder 20 is under pressure. Once storage device 14 is connected to fuel cell system 10, bladder 20 pushes fuel 15 from bladder 20 to fuel cell 12. As fuel cell 12 consumes fuel 15, bladder 20 continues to push fuel 15 from storage device 14 to fuel cell 12. As fuel cell 12 consumes fuel 15, fuel cell 12 generates electricity. When fuel cell 12 generates electricity, fuel cell 12 also produces a by-product of wastewater. The wastewater is mostly water with trace amounts of carbon dioxide and hydrogen.

As bladder 20 retracts, the volume of first cavity 30 is reduced and the volume of second cavity 32 increases. Because there are only trace amounts of air in second cavity 32, when the volume of second cavity 32 increases, a negative pressure is created in second cavity 32. The negative pressure pulls the wastewater produced at fuel cell 12 to second cavity 32. Thus, as bladder 20 pushes fuel 15 out of first cavity 30, first cavity 30 shrinks and second cavity 32 expands. The negative pressure in second cavity 32 pulls wastewater from fuel cell 12 into second cavity 32. Thus, storage device 14 operates as a result of the pressure within system 10 and no external pump is required.

Referring to FIGS. 1 and 2, storage device 14 may also be equipped with a pressure sensor 60, which monitors the pressure of either first cavity 30 or second cavity 32. Pressure sensor 60 is shown in FIG. 1 as measuring the pressure of second cavity 32. Pressure sensor 60 is shown in FIG. 2 as measuring the pressure of first cavity 30. As fuel 15 leaves first cavity 30 or as wastewater fills second cavity 32, the pressure within first and second cavity 30 and 32 will change. The pressure sensor 60 may be electronically connected to a controller (not shown). That controller may be the controller that controls the portable electronic device. The pressure sensor reads the pressure in either first or second cavity 30, 32 and then sends a signal to the controller. The controller can then process that information and calculate how much fuel is left in storage device 14. The controller can then send a signal to an indicator of the portable electronic device, which would indicate the amount of fuel 40 left in storage device 14. Alternatively, storage device 14 can also be made transparent so that the user may see the amount of fuel 15 and or wastewater located in storage device 14.

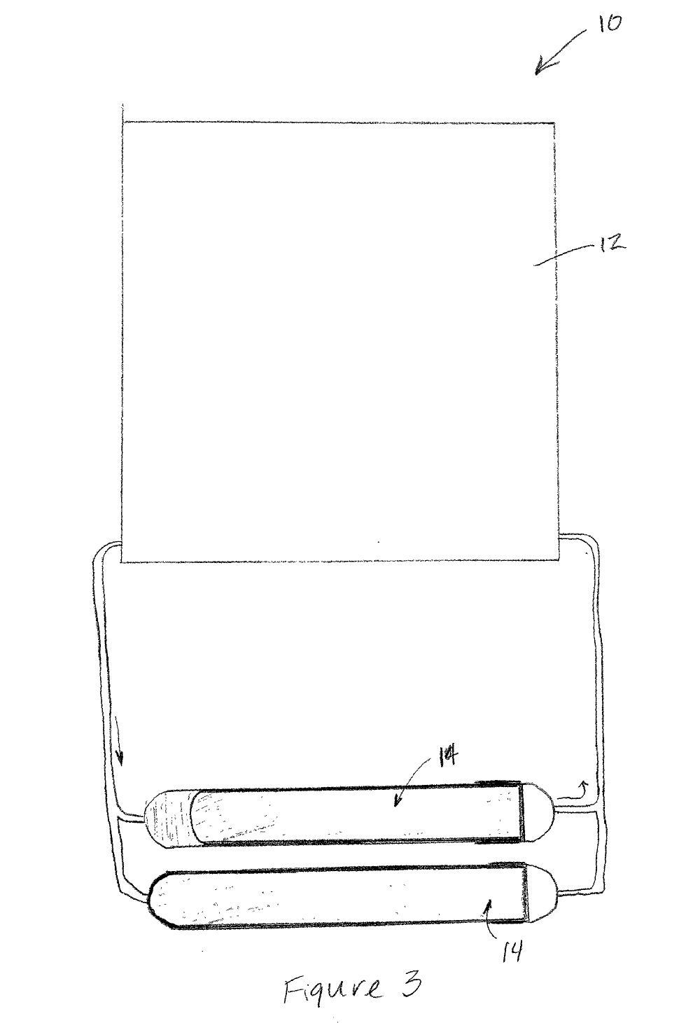

Referring to FIG. 3, an alternative exemplary embodiment illustrates fuel cell system 10 of FIGS. 1 and 2 with additional storage devices 14. Thus, a plurality of storage devices 14 may be added to fuel cell system 10.

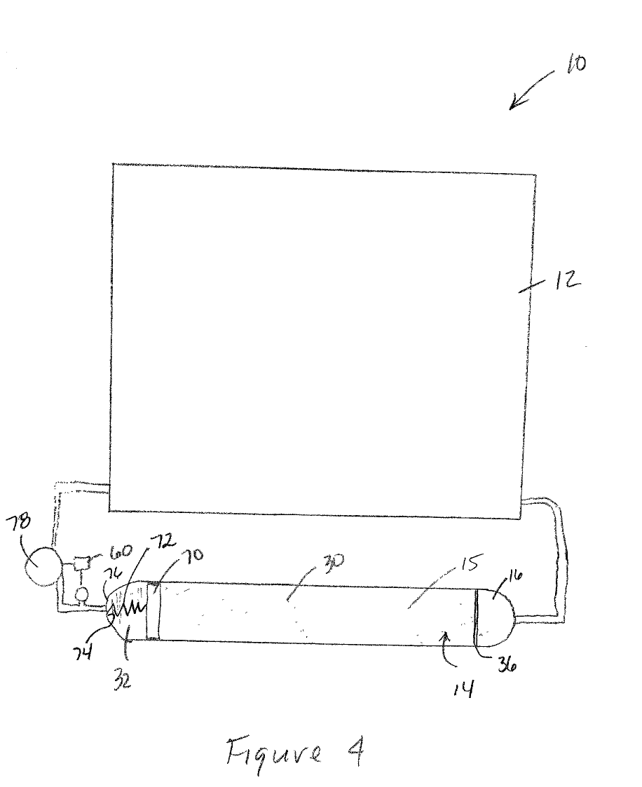

Referring to FIG. 4, an alternative exemplary embodiment illustrates fuel cell system 10. In this embodiment, storage device 14 includes first cavity 30 and second cavity 32. First cavity 30 is separated and sealed from second cavity 32 by a slidable wall 70 or piston. Slidable wall 70 may seal first cavity 30 from second cavity 32 by any manner known in the art, such as an o-ring or the like. Within second cavity 32, a spring 72 is connected to slidable wall 70 and to an interior wall 74 at a second end 76 of storage device 14. Spring 72 is fully extended when storage device 14 is empty. As fuel 15 is inserted into first cavity 30, slidable wall 70 is pushed so that first cavity 30 increases and second cavity 32 decreases in volume. As slidable wall 70 moves to increase the volume of first cavity 30, spring 72 moves to a coiled or charged position. Cap 16 is then screwed or snapped onto first end 36 and holds fuel 15 in first cavity 30. When storage device 14 is connected to fuel cell system 10, spring 72 pushes slidable wall 70 to decrease the volume of first cavity 30, thereby pushing fuel 15 out of first cavity 30 to fuel cell 12. A pump 78 pulls the wastewater from fuel cell 12 to second cavity 32. This embodiment may also include pressure sensor 60 to measure the pressure in either first cavity 30 or second cavity 32.

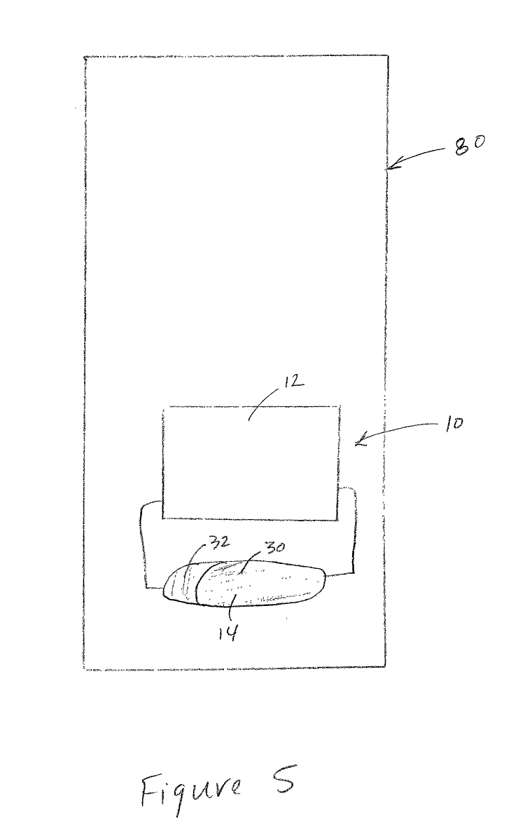

Referring to FIG. 5, fuel cell system 10 is designed to operate a portable electric device 80. Portable electric device 80 may include cellular telephones, camcorders, notebook computers, portable radios and compact disc players, portable televisions, DVD players, and the like. As such, storage device 14 is sized to fit within portable device 80. The size of storage device 14 may vary depending on the size of portable device 80 and the desired length of time fuel cell 12 operates before changing storage device 14. It is contemplated that storage device 14 may be sized to hold between 2 ounces and 14 ounces of fluid in both first cavity 30 and second cavity 32. By keeping the size of storage device 14 under 14 ounces, storage device remains small enough to fit with most portable devices and also does not add a significant amount of weight to the portable electronic device. Moreover, as the methanol and/or ethanol fuel source technology develops, the size of storage device 14 may decrease to less than 2 ounces.

Referring to FIGS. 1-5, storage device 14 provides a single device to store both the fuel to operate fuel cell 12 and the wastewater discharged from fuel cell 12. In the first embodiment, the operation of storage device 14 is simple in that there is no requirement for external pumps to operate the device. In addition, storage device 14 could also be recyclable in that the wastewater could be removed from storage device 14 and first cavity 30 refilled with fuel.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A fuel and wastewater storage device for a fuel cell comprising:
a housing having an interior;
a movable barrier dividing said interior into a first cavity and a second cavity;
a fuel port located at said first cavity; and
a wastewater port located at said second cavity,
wherein the storage device is sized to be contained within a portable electric device.

2. The device of claim 1, wherein said movable barrier is a bladder.

3. The device of claim 2, wherein said housing includes a cap and a main body, said main body having a first end, said cap is disposed at said first end.

4. The device of claim 3, where in said bladder is secured to said first end of said housing.

5. The device of claim 2, wherein said bladder is made from a flexible material.

6. The device of claim 1, wherein said movable barrier is a slidable wall.

7. The device of claim 6, further comprising a spring connected to said slidable wall and an interior wall.

8. The device of claim 1, wherein said first cavity contains a fuel.

9. A fuel cell system comprising:
a fuel cell;
a fuel and wastewater storage device in fluid communication with said fuel cell, said storage device includes:
a housing having an interior; and
a movable barrier dividing said interior into a first cavity and a second cavity.

10. The system of claim 9, wherein said movable barrier is a bladder.

11. The system of claim 10, wherein said housing includes a cap and a main body, said main body having a first end, said cap is disposed at said first end.

12. The system of claim 11, where in said bladder is secured to said first end of said housing.

13. The system of claim 10, wherein said bladder is made from a flexible material.

14. The system of claim 9, wherein said movable barrier is a slidable wall.

15. The system of claim 14, further comprising a spring connected to said slidable wall and an interior wall.

16. The system of claim 9, wherein said first cavity contains a fuel.

17. The system of claim 9, further comprising a pump in fluid communication with said storage device.

18. The system of claim 9, wherein said storage device includes a plurality of storage devices.

19. A method of storing a fuel and a wastewater at a storage device for a fuel cell system, the method comprising:
holding said fuel at a first cavity of said storage device;
moving said fuel from said first cavity to a fuel cell;
consuming said fuel at said fuel cell;
producing said wastewater at said fuel cell;
moving said wastewater from said fuel cell to a second cavity at said storage device; and
holding said wastewater at said second cavity.

20. The method of 19, wherein said moving said fuel includes pumping said fuel.
